(19) United States
(12) Patent Application Publication
(10) Pub. No.: US 2007/0017391 A1
(43) Pub. Date: Jan. 25, 2007

(54) Pad printer

(75) Inventor: Anton Kley-Bosler, Westerheim (DE)

Correspondence Address: DREISS, FUHLENDORF, STEIMLE & BECKER, POSTFACH 10 37 62, D-70032 STUTTGART, DE

(73) Assignee: TAMPOPRINT AG, Korntal-Muenchingen (DE)

(21) Appl. No.: 10/566,080

(22) PCT Filed: Jan. 29, 2004
(86) PCT No.: PCT/EP04/00763

§ 371 Date: Sep. 29, 2006

(30) Foreign Application Priority Data
Apr. 9, 2003 (DE) 103 17 283.1

(51) Int. Cl. B41F 17/00

(52) U.S. Cl. 101/41

(57) ABSTRACT

The invention relates to a pad printer comprising a rotary table (12), at least two printing blocks (16) that are located on the rotary table (12), a respective inking device (18) that is situated on each printing block (16) and can be displaced radially between an idle position and an inking position and a respective pad (24) that can be displaced vertically between an idle position and a first and second working position. According to the invention, the pad (24) and the inking device (18) are fixed to a radially displaceable carriage (14).

The invention relates to a pad printing press comprising a rotary indexing table, at least two plates arranged on the rotary indexing table, in each case an inking device arranged so as to be movable in the radial direction on the plate between a rest position and an inking position, and in each case a pad movable in the vertical direction between a rest position and a first and a second working position.

In multicolor printing presses, rotary indexing tables are known on which a plurality of complete individual pad printing presses are arranged in a star shape. As a result of the indexing of the rotary indexing table, individual pad printing presses are fed in succession to the work piece to be printed, so that the work piece is printed with the individual printing inks by means of the pad printing presses operating independently of one another.

In another multicolor printing press, a plurality of plates with inking devices are arranged on a star-shaped first carousel, and a plurality of pads on a second carousel. Two carousels intermesh with one another so that a pad always takes up printing ink from an inked plate at the point of intersection, so that the printing ink can be released to the work piece in a subsequent operation.

These devices have the disadvantage that the moving masses are either very large or that complicated adjustment work and tuning processes, particularly in the case of intermeshing carousels, are required in order to be able to print the individual printed images exactly one on top of the other.

This object is achieved, according to the invention, by a pad printing press of the type stated at the outset, if the pad and the inking device are fastened to a radially movable slide.

This pad printing press according to the invention has the substantial advantage that the masses moved by means of the rotary indexing table are reduced compared with the prior art since complete individual pad printing presses are not placed on the rotary indexing table but only slides, the slides carrying only the inking device and the pad with guide rod. Drives for the inking device and the pad are not present on the rotary indexing table.

The mass to be moved, and in particular to be accelerated and to be braked, is therefore substantially reduced compared with the known prior art. Since the plate is arranged rigidly on the rotary mixing table, the adjustment work is also shortened and more accurate prints are obtained.

According to the invention, the rotary indexing table has a cam for actuating the radial movement of the slide. This cam is formed, for example, by a control groove, which is stationary relative to the rotary indexing table in which a roller or a sliding block is guided. This roller is connected to the slide and moves the latter in the radial direction between a rest position and a working position. The slide is rigidly connected to the rotary indexing table in the direction of the rotation and is carried along by it.

According to the invention, a pad drive independent of the rotary indexing table, in particular a stationary pad drive, is provided for the pad. This pad drive, which may be hydraulic or pneumatic, electric, magnetic and/or mechanical, is likewise stationary so that it is uncoupled from the rotational movements of the rotary indexing table. For this purpose, it is necessary for it to have a coupling by means of which the pad can be coupled or uncoupled.

In order to design the drive of the rotary indexing table to be as simple as possible, the pad drive is provided above the slide. This also applies to the cam.

In order to hold and to guide the pad precisely and without vibration, the slide has a longitudinal guide for a guide rod of the pad. The longitudinal guide has a retaining device for the guide rod so that it is retained in its rest position even when it is uncoupled from the pad drive.

According to the invention, the retaining device can be deactivated after the guide rod of the pad is coupled to the pad drive via the coupling. The retaining device may also be, for example, a magnet, the retaining force of which can be overcome by the pad drive. After connection of the pad to the pad drive, the pad can immediately be moved to the desired working position, i.e. either onto the plate or onto the article to be printed or onto a cleaning device.

In order to be able to change the pad printing press according to the invention rapidly and easily to other colors, printed images, print sizes and so on, the slide with inking device and pad is in the form of a separately handled module. Repair and maintenance work and setup times are reduced to a minimum thereby.

In a preferred embodiment, the cam has an arc-shaped and an ε-shaped section and the two sections form a closed curve. Over the ε-shaped section, the inking device is moved away from the inked engraving of the plate and the pad is moved over the engraving. Because the ε-shaped section is exchangeable, the movement of the slide can be easily adapted to other plates, in particular differently dimensioned engravings.

According to the invention, more than two slides can be provided on the rotary indexing table. In the case of a five-color print, for example, five slides, in particular the same distance apart, i.e. at angular spacings of 72°, are mounted.

The pad printing press according to the invention preferably has at least one inking station, an ink collection station, an ink transfer station and a cleaning station for the pad. A plurality of stations, for example the inking station and the ink transfer station or the cleaning station, may also be combined. The cleaning of the pad can be adjusted by means of the machine control so that it does not take place after every print but after a certain number of prints.

In order easily to be able to print work pieces of different height, the distance covered by the pad to the first and/or second working position is adjustable. This is effected by specific actuation of the pad drive.

A double print, in particular in the case of poorly covering printing inks, can be achieved in a simple manner by virtue of the fact that the rotary indexing table can be reversibly driven.

Further advantages, features and details of the invention are evident from the dependent claims and from the following description in which a particularly preferred embodiment is described in detail with reference to the drawing. The features shown in the drawing and mentioned in the claims and in the description may be essential to the invention in each case individually by themselves or in any desired combination.

In the drawing:

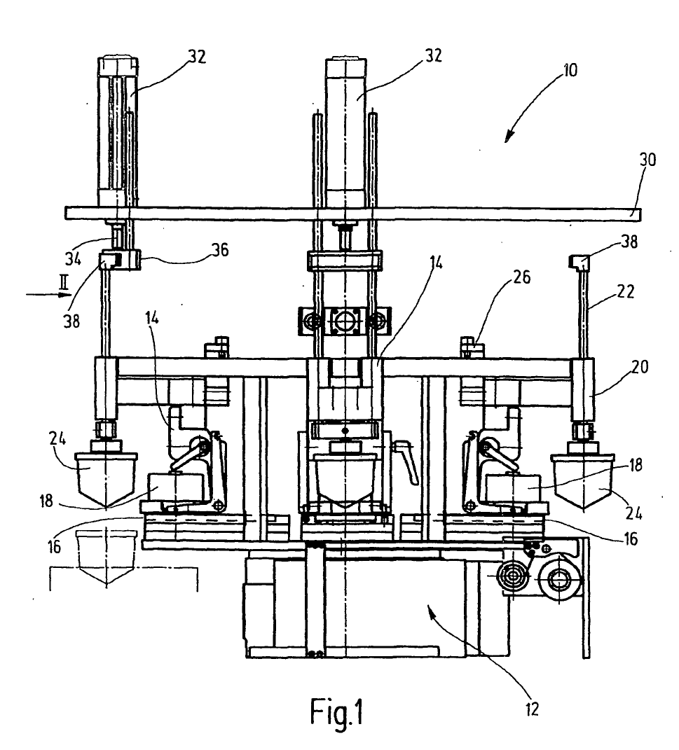

FIG. 1 shows a side view of a four-color pad printing press;

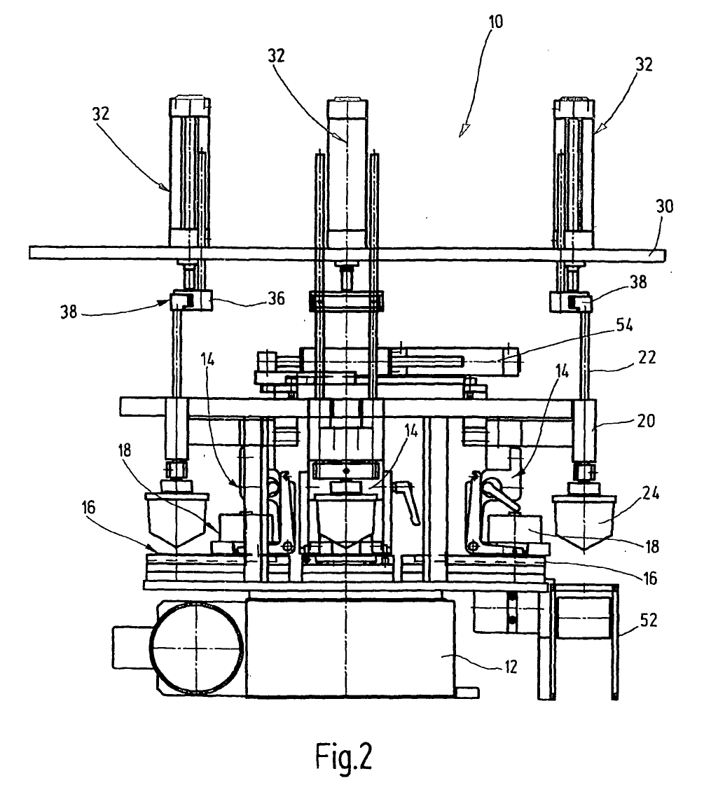

FIG. 2 shows a side view of the pad printing press in the direction of the arrow II according to FIG. 1; and

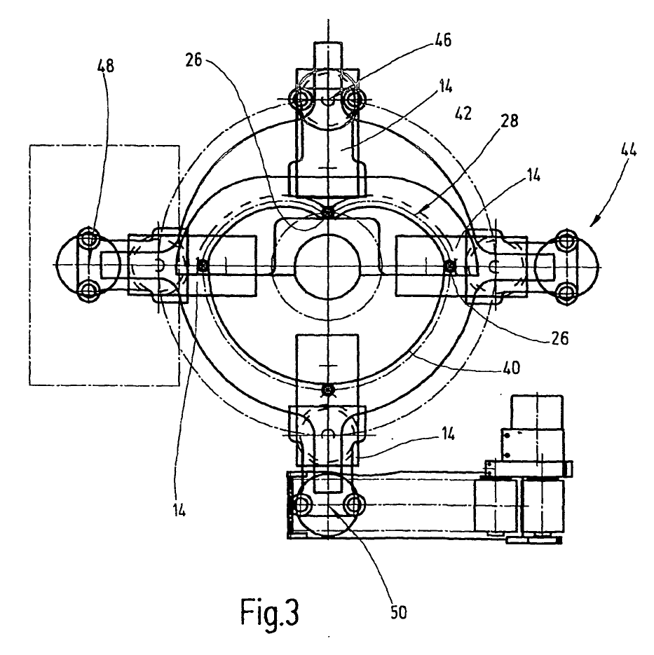

FIG. 3 shows a plan view of the pad printing press.

FIGS. 1 and 2 show a multicolor printing press that is designated as a whole by 10 and has a rotary indexing table 12 that is driven by means of an electromechanical drive (not shown). Four slides 14 are arranged uniformly over the circumference, i.e. at an angle spacing of 90°, on the rotary indexing table 12, as is clearly evident from FIG. 3. Each slide 14 is mounted so as to be displaceable in the radial direction relative to a plate 16 and carries an inking device 18 by means of which the engraving of the plate 16 is inked and scraped off by means of a doctor blade. In addition, a longitudinal guide 20 for a guide rod 22 of a vertically displaceable pad 24 is arranged on each slide 14. By means of the longitudinal guide 20, the pad 24 is precisely positioned in the vertical direction and held. Finally, each slide 14 also has a guide rod 26, which engages a stationary cam 28 arranged above the slide 14.

Above the cam 28 is a stationary frame 30 on which a total of three pad drives 32 are fastened. These pad drives 32 have pneumatic cylinders, the connecting rods 34 of which are provided with couplings 36. These couplings 36 engage counter-couplings 38 which are provided at the free, upper ends of the guide rods 22 for the pads 24. The couplings 36 and counter-couplings 38 are designed so that the counter-couplings 38 can be moved laterally into and out of the couplings 36 and can be carried along by the couplings 36 in the vertical direction.

The cam 28 has an arc-shaped section 40 extending over 180° and an ε-shaped section 42 likewise extending over 180°. In the ε-shaped section 42, the slide 14 is moved radially inwards, with the result that the inked engraving is scraped off by the inking device 18 by means of a doctor blade so that the ink can be lifted out of the engraving by the pad 24, which is likewise moved radially inwards. The slide 14 is then moved radially outwards.

To prevent printing ink from drying into the inked engraving when the pad printing press 10 is non-operational, the ε-shaped section 42 is displaced radially outwards by means of a pneumatic cylinder 54 (FIG. 2) away from the section 40. As a result of this, guide roller 26 is released from the cam 28 so that the slide 14 is not moved radially inwards. Thus, the inking device 18 remains on the inked engraving and covers it so that drying in of the ink is prevented.

The pad printing press 10 according to the invention operates as follows:

In the first station 44, the engraving of the plate 18 is inked. In the second station 46, as already mentioned, the slide 14 is moved radially inwards in order to scrape off the plate 14 by means of a doctor blade for transferring the ink present in the engraving. Before the slide 14 has completely reached the second station 46, the counter-coupling 38 of the guide rod 22 of the pad 14 travels into the coupling 36 with the result that the pad 24 is connected to the pad drive 32 of the second station 46. The pad 24 can now be moved in the vertical direction for taking up the ink from the engraving.

As soon as the slide 14 leaves the second station 46, the counter-coupling 38 is moved out of the coupling 36, and the guide rod 22 is released from the pad drive 32. The slide 14 again moves radially outwards and reaches the third station 48 in which the engraving is again inked by the inking device 18, which likewise moves radially outwards, and in which the pad 24 transfers the printing ink taken up to the print medium. Before the slide 14 completely enters the station 46, the counter-coupling 38 engages the coupling 36 of the pad drive 32 there so that the pad 18 can be moved vertically downwards onto the article to be printed.

As soon as the pad 24 has been moved upwards again to its rest position, the rotary indexing table 12 is moved on by one station so that the counter-coupling 38 disengages from the coupling 36, and the slide 14 enters the fourth station 50. This station 50 likewise has a pad drive 32 and serves for cleaning the pad 24, which, after coupling, is pressed vertically downwards onto a cleaning foil 52. This cleaning foil 52 or this cleaning belt is transported onwards by one section after each cleaning process so that fresh, unused foil is available for the next cleaning process.

After the fourth station 50, the slide 14 is moved back to the first station 44, and the printing process begins afresh.

The pad printing press 10 according to the invention has the substantial advantage that the masses moved by the rotary indexing table 12 are relatively small since all drives are stationary.

1-19. (canceled)

20. Pad printing press (10) comprising a rotary indexing table (12), at least two plates (16) arranged on the rotary indexing table (12), in each case an inking device (18) arranged so as to be movable in the radial direction on the plate (16) between a rest position and an inking position, and in each case a pad (24) movable in the vertical direction between a rest position and a first and a second working position, characterized in that the pad (24) and the inking device (18) are fastened to a radially movable slide (14).

21. Pad printing press according to claim 20, characterized in that the rotary indexing table (12) has a cam (28) for actuating the radial movement of the slide (14).

22. Pad printing press of claim 20, characterized in that the slide (14) is rigidly coupled to the rotary indexing table (12) in the direction of rotation.

23. Pad printing press of claim 20, characterized in that a pad drive (32) independent of the rotary indexing table (12), in particular a stationary pad drive (32), is provided for the pad (24).

24. Pad printing press of claim 23, characterized in that the pad (24) can be coupled to the pad drive (32) or uncoupled therefrom.

25. Pad printing press of claim 23, characterized in that the pad drive (32) is provided above the rotary indexing table (12) and in particular above the slide (14).

26. Pad printing press of claim 23, characterized in that the pad drive (32) has a hydraulic, pneumatic, electrical and/or mechanical drive.

27. Pad printing press of claim 20, characterized in that the slide (14) has a longitudinal guide (20) for a guide rod (22) of the pad (14).

28. Pad printing press of claim 27, characterized in that the longitudinal guide (20) is provided with a retaining device for the guide rod (22).

29. Pad printing press of claim 28, characterized in that the retaining device can be deactivated or can be overridden after the guide rod (22) of the pad (24) is coupled to a pad drive (32) via a coupling (36).

30. Pad printing press of claim 20, characterized in that the slide (14) with inking device (18) and pad (24) can be exchanged as a module.

31. Pad printing press of claim 21, characterized in that the cam (28) has an arc-shaped and an ε-shaped section (40 and 42) and the two sections (40 and 42) form a closed curve.

32. Pad printing press of claim 21, characterized in that the ε-shaped section (42) is movable and/or exchangeable.

33. Pad printing press of claim 20, characterized in that, in a multicolor printing press, slides (14) are provided according to the number of colors.

34. Pad printing press of claim 33, characterized in that a plurality of slides (14) are distributed uniformly over the circumference on the rotary indexing table (12).

35. Pad printing press of claim 20, characterized in that an inking station (50), an ink collection station (44), an ink transfer station (46) and a cleaning station (48) are provided for the pad (24).

36. Pad printing press of claim 20, characterized in that the distance covered by the pad (24) to the first and/or second working position is adjustable.

37. Pad printing press of claim 20, characterized in that the distance covered by the pad (24) at each station (44, 46, 48, 59) is individually adjustable and independent of one another.

38. Pad printing press of claim 20, characterized in that the rotary indexing table (12) is reversibly drivable.
